(19) United States
(12) Patent Application Publication
(10) Pub. No.: US 2004/0039720 A1
(43) Pub. Date: Feb. 26, 2004

(54) Method for providing platform independent business rules

(76) Inventors: Donna K. Hodges, Cumming, GA (US); Barrett M. Kreiner, Norcross, GA (US)

Correspondence Address: BAMBI FAIVRE WALTERS, P. O. BOX 622, KERNERSVILLE, NC, 27285, US

(21) Appl. No.: 10/029,286

(22) Filed: Dec. 31, 2001

(51) Int. Cl. G06F 7/00

(52) U.S. Cl. 707/1

(57) ABSTRACT

A method for providing platform independent business rules include encoding business rules in extensible style language translator (“XSLT”), thereby creating a platform independent XSLT business rule component, is provided. The XSLT business rule component is loaded into or coupled with a platform dependent business engine, which results in a platform dependent business engine whose behavior is based on the platform independent business rules. In particular, the method provides a way to produce or obtain a number of platform dependent business engines whose core behavior can be based on the same platform independent business rules. In addition, when the business rules change, the platform dependent business engines can be updated by encoding the changed business rules in XSLT. Similarly, XSLT encoded business rules can be used drive the core behavior of a common business service (“CBS”) unit.

### TECHNICAL FIELD

This invention relates in general to providing business rules, and in particular, to providing business rules encoded in XSLT that can be used across different platforms, regardless of the underlying programming languages.

### BACKGROUND OF THE INVENTION

The advent of the Internet and the world wide web (“the web”) has enabled a variety of “on-line” applications and transactions. Web based languages, such as hypertext markup language (“HTML”) and extensible markup language (“XML”), have been used to integrate the various software products and services needed to support such applications and transactions.

New advances are continually being made with respect to web based technologies to provide the ability to share information and data across various networks so as to further integrate products and services on the web. In this regard, extensible style language translator (“XSLT”) has been developed to transform information between different software products and services. As illustrated by FIG. 1A, XSLT 120 transforms a set of data 122 to another form 124 that is expected by a particular program. The transformation can be performed in real time so that two different software programs can be communicating with each other via XSLT without knowing that they are using different data structures.

Advances also have been made in software environments to allow for component oriented programing. With respect to application software, an entire application program has conventionally been developed as one tightly coupled program. For software developers, this conventional method required multiple development efforts to develop applications for different platforms even though the behavior of the applications, i.e., the core logic, was the same.

Among other things, developing multiple applications with the same core logic is labor intensive and inefficient. Accordingly, there have been efforts to divide an application program into several components that can be developed separately. FIG. 1B represents a conventional application 100 which is separated into a presentation component 102 and a business engine component 104. The presentation component 102 provides an interface between the application program 100 and a user or external system 106. The business engine component 104 makes logical decisions and determinations in response to input data received via the presentation component 102. The business engine component 104 also retrieves additional business data from a database 108.

In the conventional application 100 illustrated in FIG. 1B, the business rules that drive the behavior of the business engine 104 are hard-coded using the software language for a particular platform. Accordingly, a separate business engine must be developed for each platform, even though the same business rules are to be applied across different platforms.

XSLT has been used to transform a set of business rules to a platform specific set of business rules. Referring to FIG. 2A, XSLT 200 is used to transform or translate a set of generic rules written in XML 202 to a platform specific rule set 204 that becomes tightly coupled to a particular business engine 206. The platform specific rule set 204 is hard-coded into the business engine 206. If the business rules change, another transformation of the business rules 202 is required, as well as a recompilation of the business engine 206 in which the new business rules become hard-coded.

The present invention provides a method of further decoupling the business rules from the business engine. The present invention provides platform independent business rules that can be incorporated into a multitude of different platforms that use different programming languages.

### SUMMARY OF THE INVENTION

The present invention provides methods for providing platform independent business rules. In a preferred embodiment of the present invention, business rules are logically encoded using XSLT to form an XSLT business rule component. The XSLT business rule component is then loaded into or coupled with a business engine using an XML document type definition (“DTD”), thereby creating an XSLT business engine. The behavior of the XSLT business engine is driven by the business rules encoded in XSLT. The business engine provides, for example, an interface to a presentation layer and/or performs a specific task, such as a statistical analysis or allowing a user to access information.

Currently, there exist a number of XML-compatible, platform dependent business engines in the public domain. A number of platform dependent XSLT business engines can be created using the platform independent business rules of the present invention. For example, an XSLT business engine for a MACINTOSH platform and an XSLT business engine for a UNIX platform can be obtained from the same XSLT business rule component, which may be located on a WINDOWS platform. In fact, the XSLT business rule component can be located on any network resource that can be accessed by the business engine. Thus, the present invention provides a way of adaptively coupling or loading platform independent rules with a platform dependent business engine. Accordingly, the present invention further advances component-wise development for application programs.

If the business rules change, then the XSLT business rule component is updated. The business engine does not need to be recompiled. By encoding the changed business rules in XSLT, the platform dependent business engines that use the XSLT business rule component are automatically updated.

The present invention also allows a continuous cycle from the receipt of input data to manipulation of the input data to the output of the results of the manipulation. In particular, the platform independent XSLT business rule component can manipulate input data and provide an answer or decision that can be communicated to an input data source, such as a user, who can then provide additional input data that can be further manipulated by the XSLT business rule component. Thus, the present invention facilitates efficient information processing and communication.

In an environment in which common business service (“CBS”) units are used, the core logic of a CBS can be replaced by an XSLT business rule component, thereby creating an XSLT CBS unit. The XSLT business rule component encodes the rules that drive the core behavior of the XSLT CBS unit, while the CBS unit into which the XSLT business rule component is loaded or with which the XSLT business rule component is coupled provides the interface to the application program.

Thus, a number of platform dependent XSLT CBS units can be created from a single XSLT business rule component, which is platform independent. The loading or coupling of the platform independent business rule component with a platform dependent CBS unit is accomplished using an XML document type definition. As with the business engines, when the business rules change, only the XSLT business rule component needs to be changed to update the platform dependent CBS units.

An XSLT business engine or an XSLT CBS unit can also make a call to another software unit, such as a database, another CBS unit, or another business engine using a uniform resource locator (“URL”) or other addressing means. The call can be made to a local unit or a remote unit across a network, via a wired or wireless link. Thus, the present invention allows for further integration of various services and products.

These and other aspects, features and advantages of the present information may be more clearly understood and appreciated from a review of the following detailed description of the disclosed embodiments and by reference to the appended drawings and claims.

### BRIEF DESCRIPTION OF THE DRAWINGS

FIG. 1A is a block diagram illustrating a conventional transformation of a data structure to another data structure using XSLT.

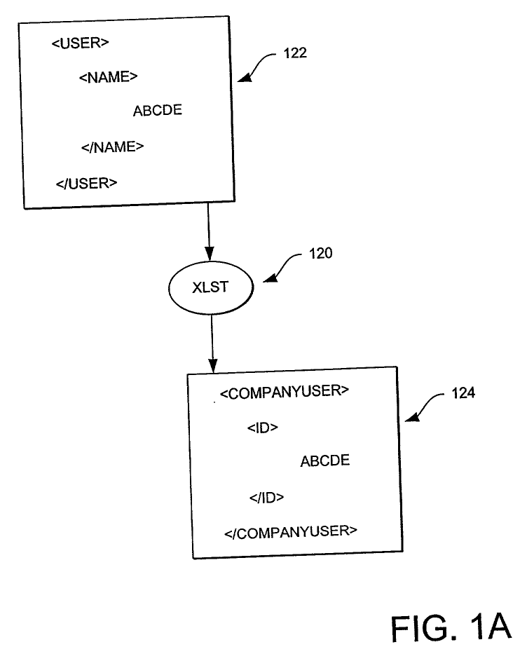

FIG. 1B is a block diagram illustrating a conventional application program.

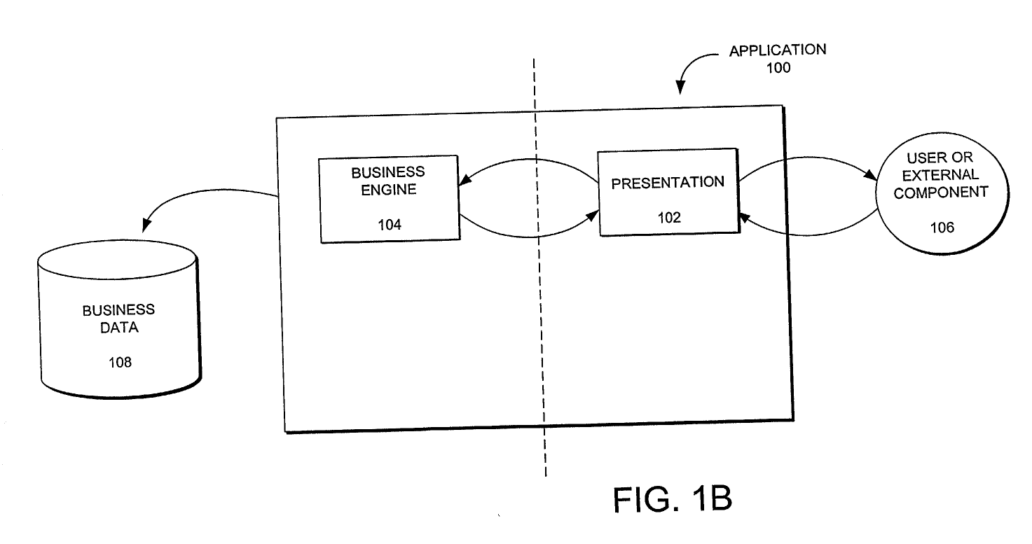

FIG. 2A is a block diagram illustrating a conventional business rule transformation using XSLT.

FIG. 2B is a block diagram illustrating the use of XSLT rules in different business engines according to the present invention.

FIG. 3 is a block diagram illustrating an exemplary operating environment for an embodiment of the present invention.

FIG. 4 is a block diagram illustrating exemplary components within a business rule component according to the present invention and an exemplary environment in which such a component can be used.

FIG. 5 is a block diagram illustrating another exemplary environment in which a business rule component according to the present invention can be used.

FIG. 6A is a block diagram illustrating another exemplary environment in which a business rule component according to the present invention can be used.

FIG. 6B is a process flow diagram contrasting the flow of information for a conventional method with that for the present invention for an exemplary validation process.

### DETAILED DESCRIPTION OF THE INVENTION

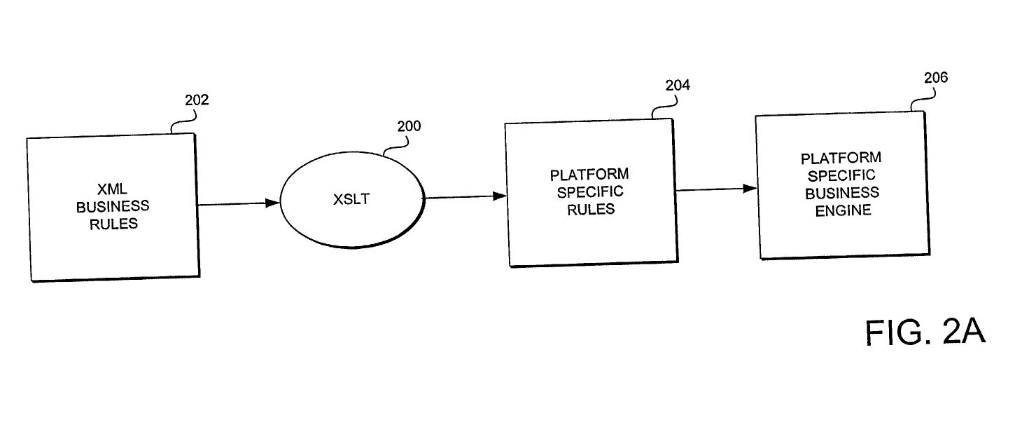

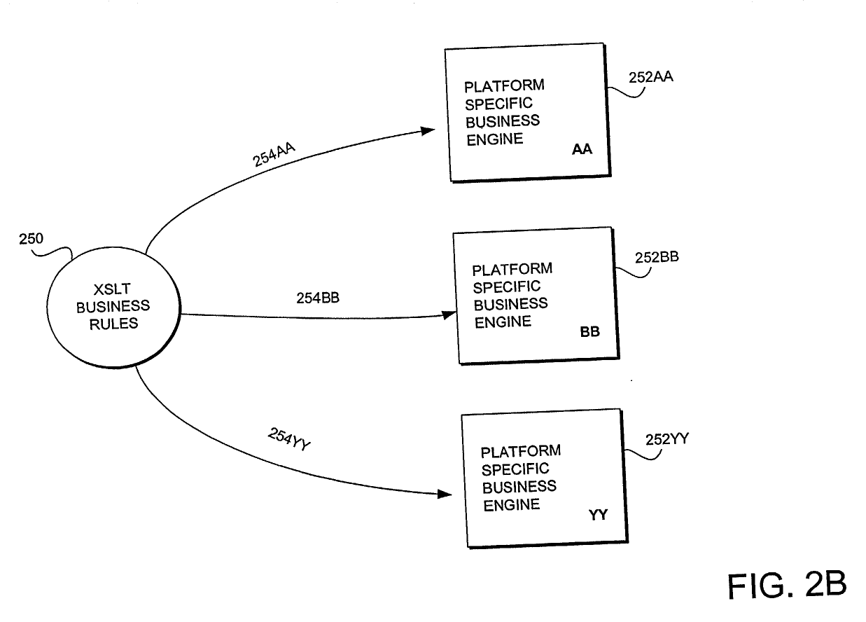

Using a conventional method to obtain a number of business engines deployable across different platforms requires that the translation process illustrated in FIG. 2A be repeated for each business engine. The same business rules have to be transformed multiple times to provide platform dependent business rule sets that are hard-coded in platform dependent business engines.

The present invention allows the same business rules to be deployed across a number of platform dependent business engines by encoding the business rules in XSLT. As shown in FIG. 2B, the XSLT business rule component 250 can be used in a number of platform dependent business engines, collectively designated as 252. Elements 254AA, 254BB, 254YY represent loading or coupling the XSLT business rule component 250 with each of the platform dependent business engines 252AA, 252BB, 252YY. Accordingly, the present invention removes the delay and inefficiency associated with developing business engines using the conventional methods.

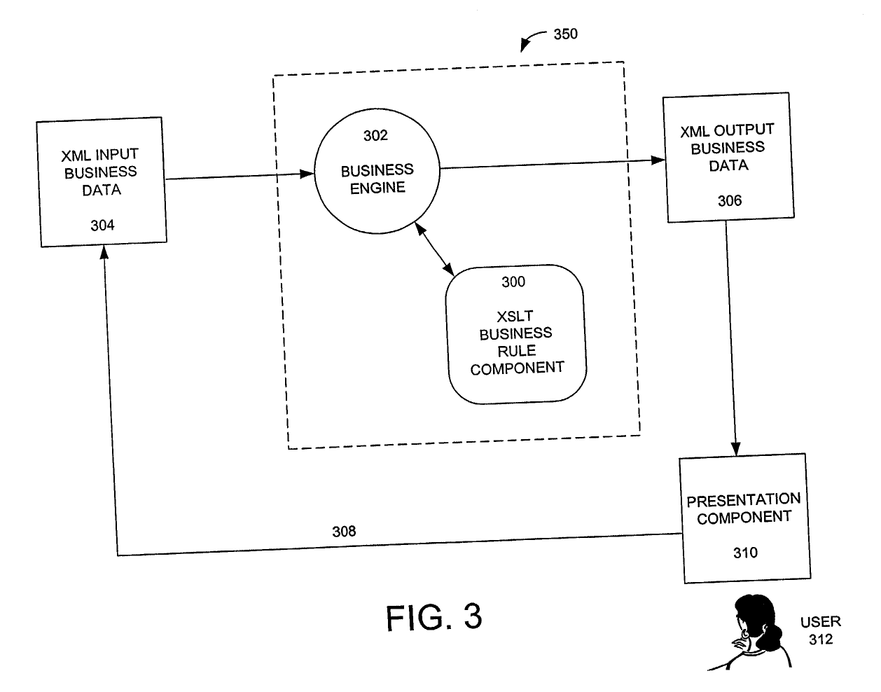

Referring to FIG. 3, the present invention is further described. A set of business rules is encoded in XSLT to create an XSLT business rule component 300. The XSLT business rule component 300 drives the platform dependent business engine 302. The business rule component 300 is developed independently from the business engine 302 and is platform independent.

The business engine 302 performs particular services or tasks based on the underlying business rules. An exemplary task may be performing statistical analysis of accounts receivable. Another exemplary task may be performing user validation. To perform either of these tasks, certain business rules are required. For the first example, the business rules define the types of accounts to be treated as accounts receivable and the period after which an account receivable is treated as a loss. For the second example, the business rules define what information is required to validate a user, e.g., user name, telephone, and password. A number of business engines are available in the public domain for different platforms that use different languages, including the JAVA, C⁺⁺ and PEARL languages. Thus, once a platform independent set of business rules is developed, multiple business engines can operate on the same business rules without additional coding and/or compiling.

The business engine 302 is implemented using a particular programming language and thus is platform dependent. However, the business engine 302 is implemented so that it is XML compatible. The coupling between the XSLT business rule logic component 300 and the business engine 302 is established via an XML document type definition (“DTD”). The DTD describes the form of data which will be passed between the XSLT business rule component 300 and the platform dependent business engine 302. Once the business rule component 300 becomes loaded into the business engine 302, an XSLT business engine 350 results.

The actual behavior prescribed by the business rules, which are encoded in XSLT, can be moved from one platform to another, without having to rewrite the rules for each and every platform. Accordingly, the present invention provides a way to create portable or platform independent business rules. If the business rules change, only the XSLT business rule component 300 needs to be changed. The business engine 302 does not need to be rewritten.

Because the business rules are encoded in XSLT, input business data 304 can be logically manipulated and presented as output business data 306, which can be, among other things, decisions and determinations made by the business engine 302 based on the XSLT business rule component 300. In this regard, XSLT is used to perform logical manipulations of the input data 304 and to produce, among other things, answers, validations and decisions, in response to the input data 304. In a preferred embodiment the input and output business data are provided in XML.

Furthermore, a feedback loop 308 between the XML input business data 304 and the XML output business data 306 enables a continuous cycle from the input business data 304 to the output business data 306. For example, using a presentation component 310, the output business data 306 can be presented to a user 312. The user's response is then received as additional input business data that can be manipulated to perform certain logical functions, such as user validation, access decisions, and error handling. After the logical manipulation of the input business data, new business output data is presented to the user 312, who then can enter additional input business data.

The XSLT business rule component 300 can reside either locally or remotely to the business engine 302. The XSLT business rule component 300 can be accessed by the business engine 302 via a network, including a wired or wireless link. For example, a business engine written for a MACINTOSH server can pull an XSLT business rule component stored on a UNIX server over the Internet, thereby creating an XSLT business engine that can run on a MACINTOSH platform. In particular, both the UNIX and MACINTOSH servers can have their platform specific business engines running on the same platform independent business rules.

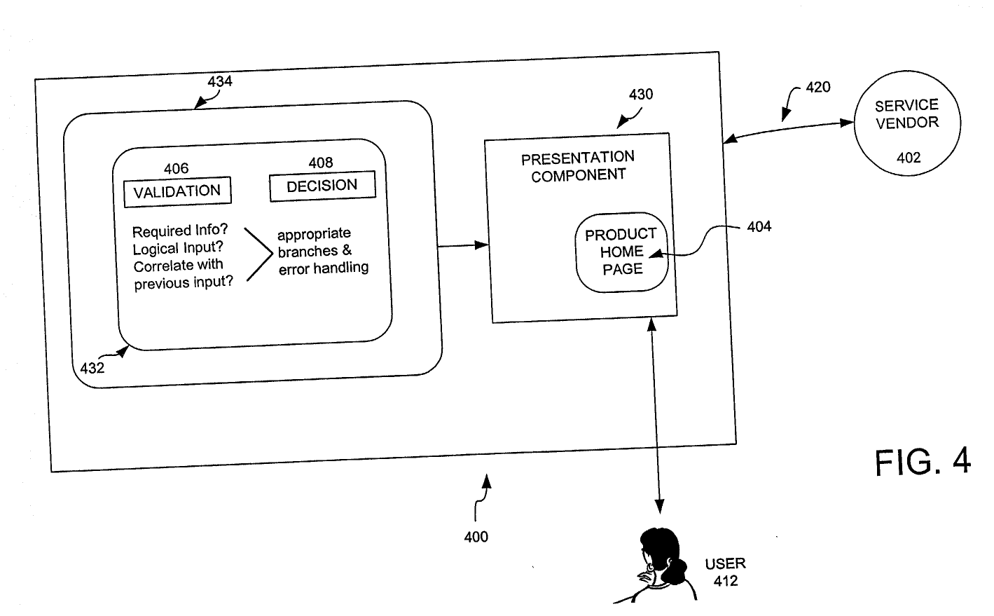

Referring to FIG. 4, exemplary components within an XSLT business rule component and its platform environment are described. A platform 400 includes a business engine 434 and a presentation component 430. A service vendor 402 provides a product home page 404 via the platform 400. In particular, the presentation component 430 determines the manner in which the product home page 404 is displayed to the user 412. The service vendor 402 communicates with the platform 400 via a communication link 420, which can be any form, including wired, wireless, or a combination thereof.

The XSLT business engine 434 incorporates an XSLT business rule component 432 encapsulating the business rules of the vendor 402 for the product made available via the product home page 404. The XSLT business rule component 432 includes, among other things, a validation component 406 and a decision component 408. For example, the validation component 406 determines if the user 412 entered all required information, if the information entered by the user 412 makes logical sense, and if the information entered by the user 412 is compatible with information previously received regarding the user 412. The decision component 408 makes appropriate decisions based on the output of the validation component 406. For example, the decision component 408 may indicate to the presentation component that the user is a valuable customer who should be given service points that can be used at a later time, or that the user did not provide required information. The presentation component 430 then presents appropriate displays to the user 412. In this regard, the XSLT business rule component 432 is used to make validations and decisions based on a set of business rules particular to the service vendor 402.

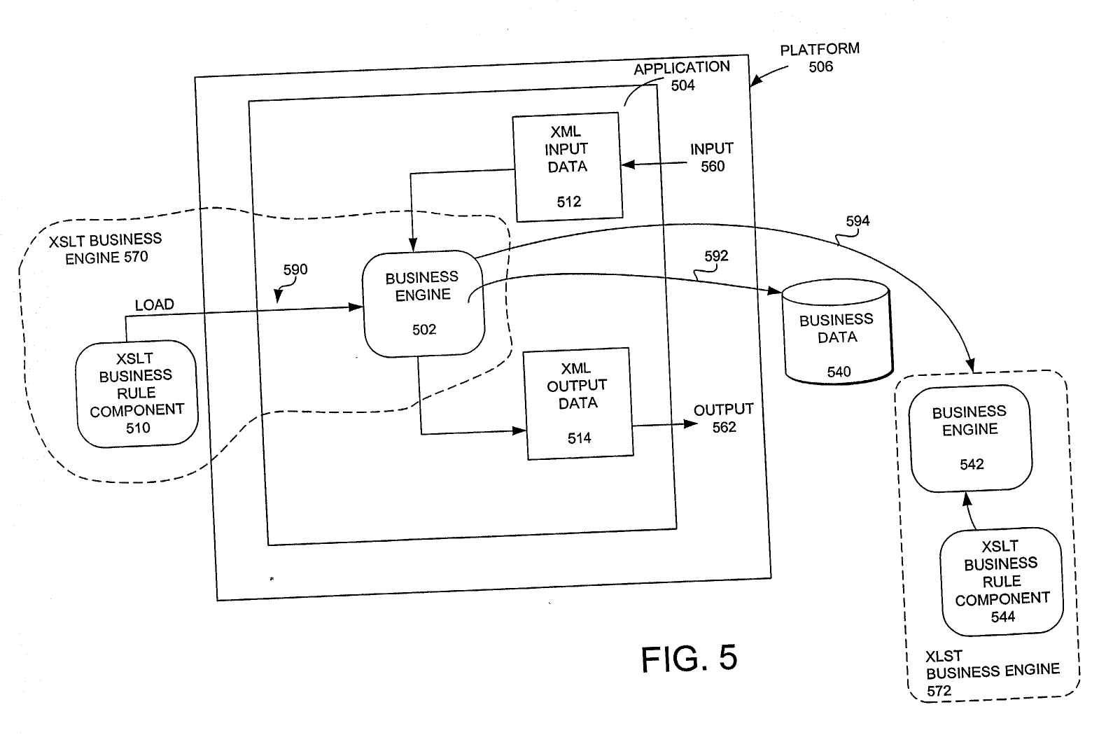

Referring to FIG. 5, a business engine 502 is hosted on an application program 504 residing on a particular platform 506, such as a MACINTOSH, UNIX, or WINDOWS platform. The business engine 502 is written in a language that is compatible with the application program 504 and the platform 506.

When an XSLT business rule component 510 is loaded (element 590) into the business engine 502, an XSLT business engine 570 results. The application program 504 provides input data in XML 512, to the business engine 502, and the business engine 502 provides output data in XML 514, to the application program 504. In particular, the XML output data 514 is produced based on the XSLT business rule component, and the process flow from the input 560 to the output 562 can be continued in response additional XML input data which can be received via the application program 504.

In addition, the business engine 502 can make a call to access another database 540 based on a determination that it needs additional business rules or data which are available in the database 540. Similarly, the business engine 502 can make a call to another business engine 542 based on a determination that it needs a business rule decision which is performed by that business engine 542. In this example, the business engine 542 incorporates an XSLT business rule component 544. The calls 592 and 594 can be made using a Uniform Resource Locator (“URL”) or any suitable addressing means. The calls 592 and 594 can be made via any gateway and via any communication links, including wired or wireless. A typical result of the call 592 is the receipt of additional data from the database 540. A typical result of the call 594 is the receipt of a decision from the business engine 542.

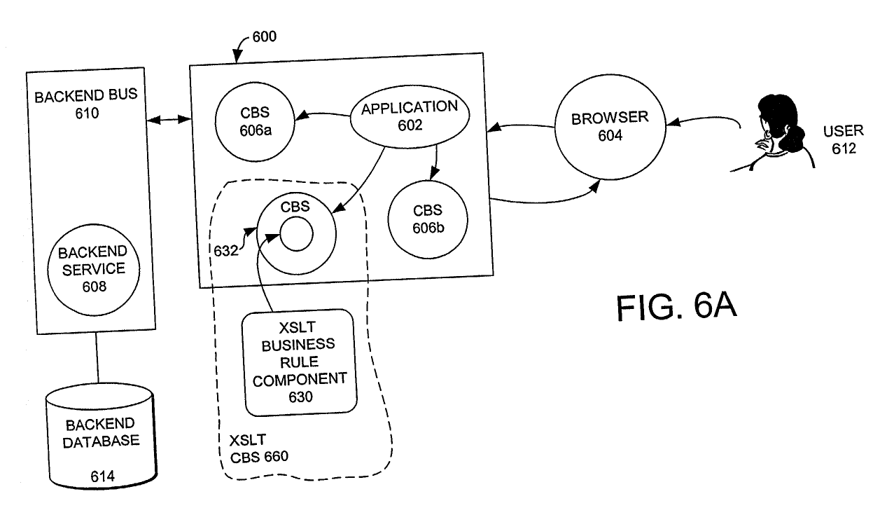

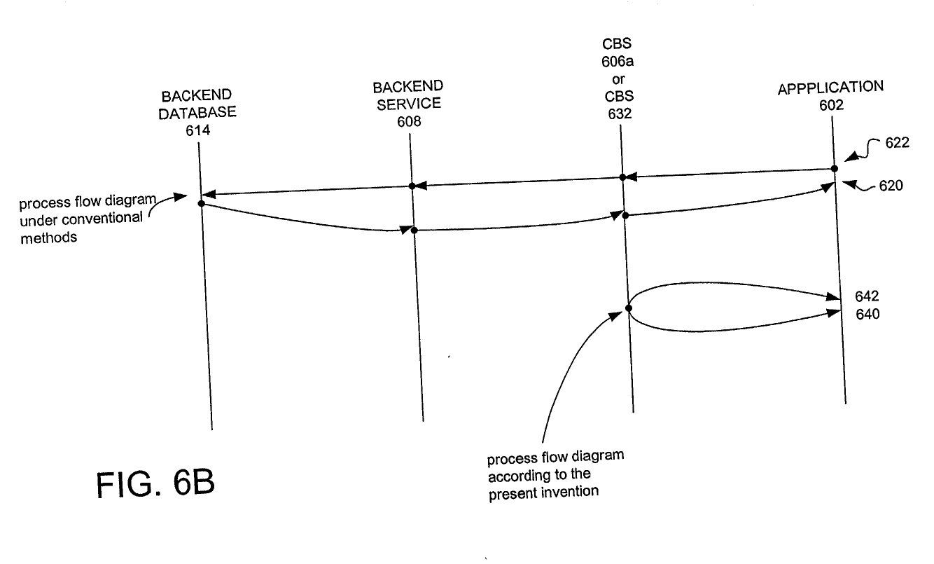

Referring to FIGS. 6A and 6B, another advantage of the present invention is described. A web application server 600 includes, among other things, an application program 602 and, typically, a number of common business service (“CBS”) units, collectively designated as 606. The application program 602 provides information to and receives information from a user 612 via a browser 604. In general, the CBS unit 606a performs a particular service requested by the application program 602 in response to the user's input and communicates with a backend service 608 via a backend bus 610. In general, the backend service 608 accesses a backend database 614, which includes the business rules for the CBS 606a.

For example, assume a telephone number validation process is required between the application server 600 and the user 612. Assume further that a business rule requires the input telephone information be in one of the following forms: (NNN) XXX-YYYY, NNN-XXXX-YYY, or NNNXXXYYY. In conventional systems, the business rule defining the acceptable forms of an input telephone number is stored in the database 614. Accordingly, conventional methods of validating a telephone number require sending information from the application program 602 to the backend database 614 and sending information from the backend database 614 to the application program 602. In other words, referring to FIG. 6B, to generate a validation output 620, the input data 622 needs to be communicated across four nodes, the application 602, the CBS 606a, the backend service 608 and the backend database 614.

In contrast, an application server 600 utilizing an XSLT business rule component 630 according to the present invention only needs to communicate the information across two nodes. For example, assume an XSLT business rule component 630 is loaded into a CBS 632, thereby creating an XSLT CBS unit 660. The CBS 632 encapsulates the rules for interacting with the application program 602, while the rules regarding acceptable forms of a telephone number are encapsulated in the XSLT business rule component 630. Accordingly, when the application program 602 receives telephone information from the user 612, the CBS 632 can validate the information without reaching back to the backend database 614.

Referring to FIG. 6B, for the same telephone number validation example discussed above, a validation output 640 is generated after the input data 642 is communicated across only two nodes: the application program 602 and the CBS 632. Accordingly, the present invention allows the application server 600 to validate input information without accessing the backend database 614. This advantage becomes particularly significant if the application server 600 resides on a wireless platform, where communication to the backend device is costly.

As another example, if twelve (12) parameters are required for validation, conventional methods transmit the twelve parameters sequentially to the backend service 608 which accesses the business rules in the backend database 614. If the eleventh parameter is invalid, an error message is not sent until after eleven (11) parameters have been evaluated and communicated through the application program 602, the CBS 606a, the backend service 608, and the backend database 614, which process represents a waste of network resources. Furthermore, re-entry and re-validation of the twelve parameters are still needed. In contrast, the present invention allows the business rules for the twelve parameters to be encapsulated in an XSLT business rule component. Thus, the validation of and decisions regarding the twelve parameters can be completed without using the communication link to a backend device, thereby eliminating the delay and inefficient use of network resources associated with conventional methods.

Another advantage of the present invention is that when the business rules change, only the XSLT business rule component 630 needs to be updated. The business rule component 630 in turn facilitates automatic updates of all CBS's that use the XSLT business rule component. The CBS's could be designed to reload the XSLT business rule component periodically or to reload the XSLT business rule component whenever there has been a change. Thus, by encoding business rules in XSLT, a platform independent business rule component that can be deployed across platforms using different languages is created.

Additional alternative embodiments will be apparent to those skilled in the art to which the present invention pertains without departing from its spirit and scope. Accordingly, the scope of the present invention is described by the appended claims and is supported by the foregoing description.

What is claimed is:

1. A method for providing a business engine using platform independent business rules, comprising:
providing a platform dependent business engine;
encoding a set of business rules in extensible style language translator (“XSLT”) to obtain an XSLT business rule component comprising the platform independent business rules, the XSLT business rule component operative to perform logical manipulations based on the platform independent rules; and
coupling the XSLT business rule component with the platform dependent business engine to create the business engine using the platform independent business rules.

2. The method of claim 1, further comprising:
providing an updated XSLT business rule component comprising updated platform independent business rules; and
loading the updated XSLT business rule component into the platform dependent business engine to obtain an updated business engine using the updated platform independent business rules.

3. The method of claim 1, further comprising:
employing an extensible markup language (“XML”) document type definition to facilitate coupling the XSLT business rule component with the platform dependent business engine.

4. A method of providing a plurality of business engines that include platform independent business rules, the method comprising:
encoding a set of business rules in extensible style language translator (“XSLT”) to obtain the platform independent business rules; and
coupling the platform independent business rules with a plurality of platform dependent business engines using an extensible markup language (“XML”) document type definition to provide the plurality of business engines.

5. The method of claim 4, further comprising:
providing updated platform independent business rules by updating the platform independent business rules using XSLT; and
coupling the updated platform independent business rules with each of the plurality of platform dependent business engines to obtain an updated plurality of platform dependent business engines.

6. A method for providing a common business service (“CBS”) unit used in conjunction with an application program, the CBS unit using platform independent business rules, comprising:
encoding a set of business rules in extensible style language translator (“XSLT”) to obtain an XSLT business rule component comprising the platform independent business rules, the XSLT business rule component operative to perform logical manipulations based on the platform independent business rules;
providing a platform specific CBS unit; and
coupling the XSLT business rule component with the CBS unit to obtain the CBS unit using the platform independent business rules.

7. The method of claim 6, further comprising:
providing an updated XSLT business rule component comprising updated platform independent business rules by updating the platform independent business rules using XSLT; and
coupling the CBS unit with the updated XSLT business rule component to obtain an updated CBS unit using the updated platform independent business rules.

8. The method of claim 6, wherein an extensible markup language (“XML”) document type definition is used to couple the XSLT business rule component and the CBS unit.

9. A method for manipulating input data and providing output data, comprising:
encoding a set of business rules in extensible style language translator (“XSLT”) to obtain a set of XSLT business rules;
coupling the set of XSLT business rules with a platform dependent business engine to obtain an XSLT business engine; and
using the XSLT business engine to:
receive the input data from a source;
perform a logical manipulation of the input data based on the XSLT business rules; and
provide the output data to the source.

10. The method of claim 9, further comprising:
providing updated XSLT business rules by updating the set of XSLT business rules using XSLT; and
updating the XSLT business engine by coupling the updated XSLT business rules with the platform dependent business engine.

11. The method of claim 9, wherein a call to a remote database is made as a result of the logical manipulation.

12. The method of claim 9, wherein a call to another business engine is made as a result of the logical manipulation.

13. The method of claim 9, wherein when the logical manipulation comprises a validation of the input data.

14. The method of claim 9, further comprising:
using an extensible markup language (“XML”) document type definition to facilitate coupling of the set of XSLT business rules with the platform dependent business engine.

15. A method for performing a task requested by an application program comprising:
encoding a set of business rules in extensible style language translator (“XSLT”) to obtain platform independent business rules;
coupling the platform independent business rules with a platform dependent common business service (“CBS”) unit to obtain an XSLT CBS unit; and
using the XSLT CBS unit to:
receive input data from the application program;
perform a logical manipulation of the input data based on the platform independent business rules; and
provide output data based on the logical manipulation.

16. The method of claim 15, further comprising:
providing updated platform independent business rules by updating the platform independent business rules using XSLT; and
coupling the CBS unit with the updated platform independent business rules to obtain an updated CBS unit.

17. The method of claim 15, further comprising:
using an extensible markup language (“XML”) document type definition to facilitate coupling the platform independent business rules with the platform dependent CBS unit.

18. The method of claim 15, wherein the output response is provided to the application program.

19. The method of claim 15, wherein the output response is a call to another software unit.

20. A computer-readable medium containing computer-executable instructions comprising:
a set of business rules encoded in extensible style language translator (“XSLT”), wherein the encoded set of business rules can be adaptively coupled with a platform dependent business engine using a document type definition to provide a platform dependent business engine having behavior based on the set of business rules encoded in XSLT.
